(19) United States
(12) Patent Application Publication
(10) Pub. No.: US 2008/0149552 A1
(43) Pub. Date: Jun. 26, 2008

(54) STRAINER BOARD WITH SNAP-IN POP STRAINER

(76) Inventor: Thomas B. Murphy, Arlington, TX (US)

Correspondence Address: Daniel V. Thompson;Thompson & Gustavson, LLP, 9304 Forest Lane, Suite N253, Dallas, TX, 75243, US

(21) Appl. No.: 11/940,981

(22) Filed: Nov. 15, 2007

Related U.S. Application Data
(63) Continuation-in-part of application No. 11/163,535, filed on Oct. 21, 2005.

(51) Int. Cl. B01D 63/00

(52) U.S. Cl. 210/251

(57) ABSTRACT

A strainer board has a main cutting surface and a strainer basket. The strainer basket has is adapted to be removably inserted into an aperture in the main cutting surface. Cooperating structure on the basket perimeter and the cutting surface aperture are adapted and arranged to permit positive engagement and disengagement of the basket and aperture under finger pressure and to prevent inadvertent disengagement when the strainer board is in a vertical orientation.

### CROSS REFERENCE TO RELATED APPLICATION

This is a continuation-in-part of U.S. patent application Ser. No. 11/163,535 filed 21-OCT-2005.

### FIELD OF THE INVENTION

This invention relates generally to kitchen accessories, and, more particularly, to cutting boards with strainer sections.

### BACKGROUND OF THE INVENTION

It is known to combine a strainer with a cutting board, called a strainer board. This permits chopped and cut ingredients on the board to be rinsed, drained, and strained prior to use. The strainer board is typically situated over a kitchen sink when in use. The strainer section can either be integrally formed with the cutting board, as in the case of the prior art Dexas BasketBoard, or be removable, as in U.S. Pat. No. 6,276,675 to Ellis N. Shamoon. A new development in the strainer art generally relates to flexile membrane strainers, disclosed in U.S. patent application Ser. No. 11/163,535 filed 21-OCT-2005. The membrane strainer can be collapsed to be thin, for example, nearly as thin as a cutting board, but in a strainer board the strainer basket must be secured to the board in manner that it does not fall out when the board is stored vertically on edge, yet permits easy removal for cleaning. Thus there exists a need for a mounting structure that removably secures a membrane strainer to a cutting board to form an easily stored strainer board.

### SUMMARY OF THE INVENTION

A strainer board has a main cutting surface and a strainer basket. The strainer basket has is adapted to be removably inserted into an aperture in the main cutting surface. Cooperating structure on the basket perimeter and the cutting surface aperture are adapted and arranged to permit positive engagement and disengagement of the basket and aperture under finger pressure and to prevent inadvertent disengagement when the strainer board is in a vertical orientation.

### BRIEF DESCRIPTION OF DRAWINGS

A more complete understanding of the invention and its advantages will be apparent from the Detailed Description taken in conjunction with the accompanying Drawings, in which:

FIG. 1 is a perspective view of the strainer board of the present invention;

FIG. 2 is an exploded view thereof;

FIG. 3 is a top plan view thereof;

FIG. 4 is a bottom plan left side elevational view thereof;

FIG. 5 is a sectional view taken along lines 5-5 of FIG. 3; and

FIG. 6 is an expanded view of the cooperating structure that enables removable engagement of the strainer basket and aperture; and

FIG. 7 is a partially broken away side elevational view of the strainer board in operation.

### DETAILED DESCRIPTION

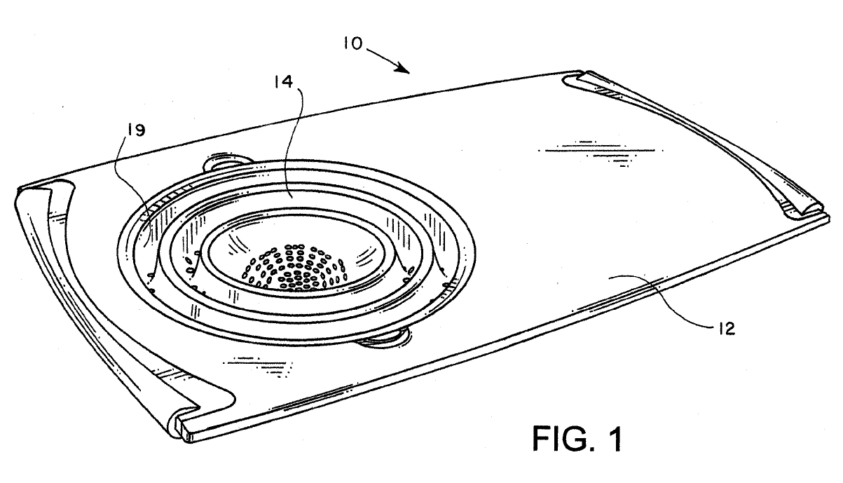

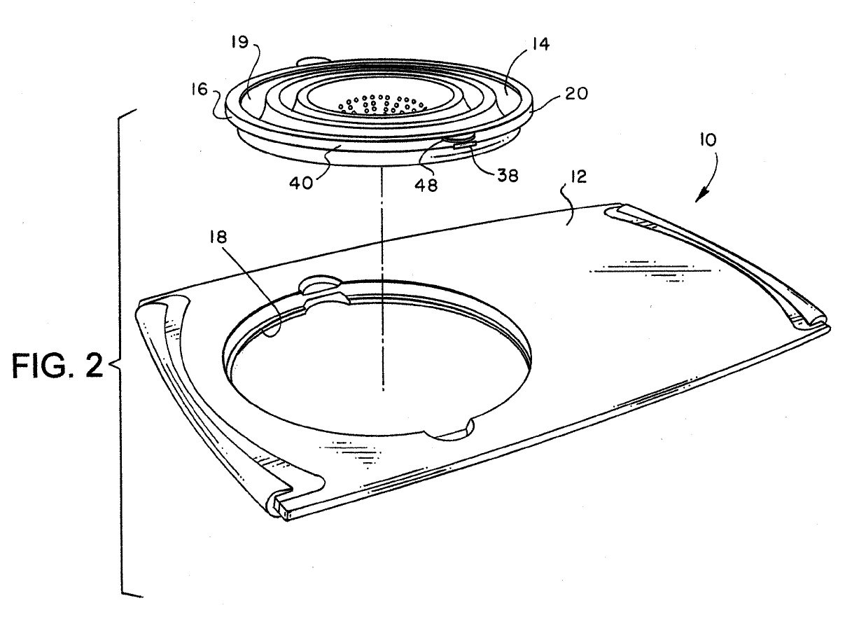

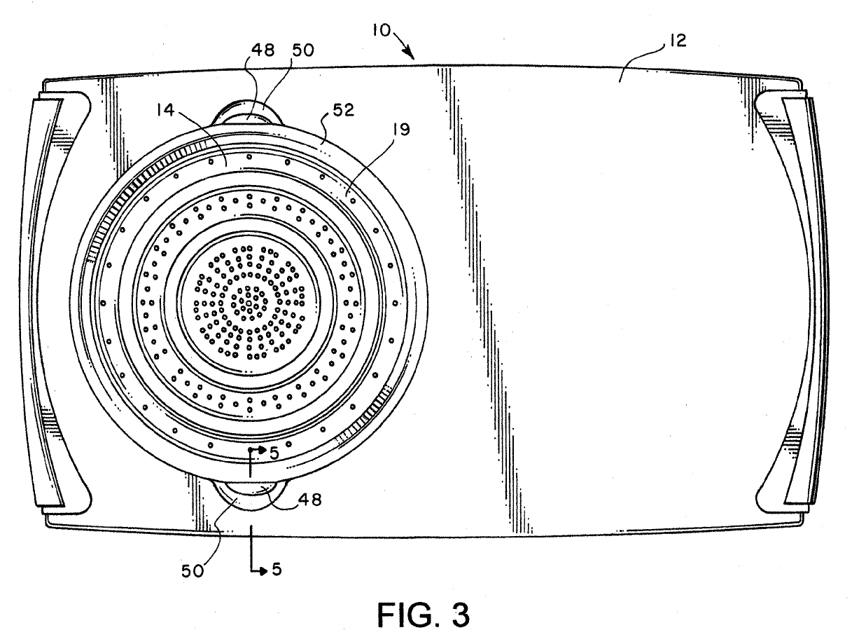

Referring to FIGS. 1-7, where like numerals refer to like and corresponding parts, a strainer board 10 has a main cutting surface 12 and a bottom surface 13. A strainer basket 14 has a perimeter 16 and is adapted to be removably inserted into an aperture 18 in the main cutting surface 12. Strainer basket 14 may include a strainer 19 be of the flexile membrane type, however, other strainer types may be used.

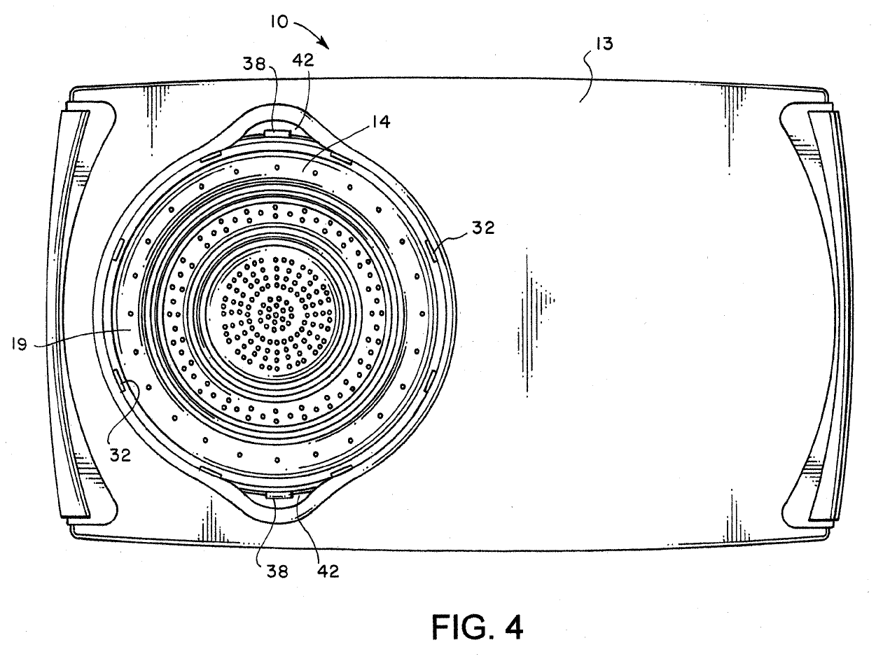

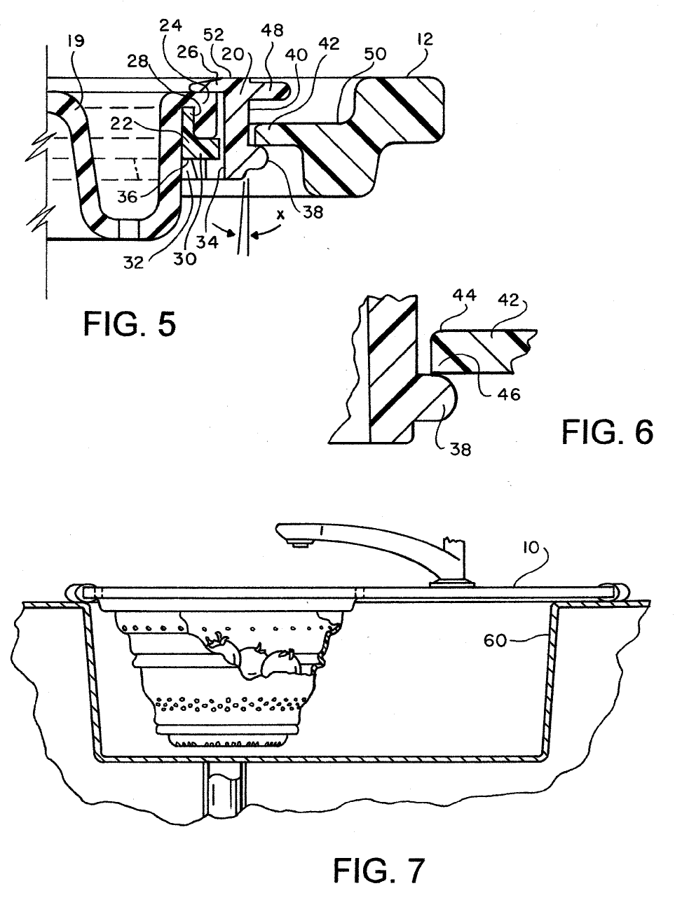

Referring to FIGS. 4 and 5, where the basket 14 includes a flexile membrane strainer, a hard plastic outer retainment ring 20 defines the perimeter 16 and a hard plastic inner retainment ring 22 is also provided. The strainer 19 has is formed with an outer lip 24 captured by an inner lip 26 of the outer retainment ring 20 and an outer side wall 28 and outer lip 30 of the inner retainment ring 22. The outer retainment ring 20 has a plurality of tapered retainers 32 extending inwardly from an inner wall 34, with the retainers 32 engaged with a lower wall 36 of the outer lip 30 of the inner retainment ring 22 to permanently fix the retainment rings 32 to the membrane strainer 19.

Cooperating structure is provided to removable secure the strainer basket 14 in aperture 18. The cooperating structure includes a pair of semi-cylindrical engagement ridges 38 disposed at opposite diametrical locations on an outer wall 40 of the outer retainment ring 20. The aperture 18 includes a pair of engagement lips 42 disposed at opposite diametrical locations, the engagement lips 42 having rounded upper corners 44 and sharp lower corners 46 to engage the engagement ridges 38.

A pair of handles 48 extends from the outer wall 40 of the outer retainment ring 20 above the engagement ridges 38. A pair of depressions 50 is located in the aperture 18 above the engagement lips 42, with the depressions 50 sized to receive the handles 48. An upper wall 52 of the outer retainment ring 20 is substantially flush with the main strainer board surface 12 when the basket 14 and aperture 18 are engaged. To facilitate insertion, the outer wall 40 of the outer retainment ring 20 is tapered in the amount of angle X, which may be about five degrees.

In operation, as shown in FIG. 7, strainer board 10 may be placed across a sink 60 with the basket 14 extending down into the sink. Strainer 19 may be collapsed as shown in FIGS. 1-4, disengaged from the board, and washed separately if desired. The strainer and board may then be re-engaged and stored vertically. The cooperating structure on the basket perimeter 16 and the cutting surface aperture 18 is adapted and arranged to permit positive engagement and disengagement of the basket 14 and aperture 18 under finger pressure and to prevent inadvertent disengagement when the strainer board 10 is in a vertical orientation. Engagement ridges 38 and engagement lips 40 are precisely dimensioned, and perimeter 16 is slightly deformable, such that ridges 38 “snap” over lips 40 as they engage and disengage.

It will be understood that each of the elements described above, or two or more together, may also find a useful application in other types of constructions differing from the type described above.

While the invention has been illustrated and described as embodied in a particular strainer board, it is not intended to be limited to the details shown, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is:

1. A strainer board, comprising:
a main cutting surface;
a strainer basket having a perimeter and adapted to be removably inserted into an aperture in the main cutting surface; and
cooperating structure on the basket perimeter and the cutting surface aperture adapted and arranged to permit positive engagement and disengagement of the basket and aperture under finger pressure and to prevent inadvertent disengagement when the strainer board is in a vertical orientation.

2. The strainer board of claim 1 with the basket including a flexile membrane strainer, a hard plastic outer retainment ring defining the perimeter and a hard plastic inner retainment ring.

3. The strainer board of claim 2 with the strainer having an outer lip captured by an inner lip of the outer retainment ring and an outer side wall and outer lip of the inner retainment ring, and the outer retainment ring having a plurality of tapered retainers extending inwardly from an inner wall, with the retainers engaged with a lower wall of the outer lip of the inner retainment ring to permanently fix the retainment rings to the membrane strainer.

4. The strainer board of claim 1 with the cooperating structure including a pair of semi-cylindrical engagement ridges disposed at opposite diametrical locations on an outer wall of the strainer basket, and with the aperture including a pair of engagement lips disposed at opposite diametrical locations.

5. The strainer board of claim 4 with the engagement lips having rounded upper corners and sharp lower corners to engage the engagement ridges.

6. The strainer board of claim 2 with the cooperating structure including a pair of semi-cylindrical engagement ridges disposed at opposite diametrical locations on an outer wall of the outer retainment ring, and with the aperture including a pair of engagement lips disposed at opposite diametrical locations.

7. The strainer board of claim 6 with the engagement lips having rounded upper corners and sharp lower corners to engage the engagement ridges.

8. The strainer board of claim 7 a pair of handles extending from the outer wall of the outer retainment ring above the engagement ridges.

9. The strainer board of claim 8 with a pair of depressions in the aperture above the engagement lips sized to receive the handles.

10. The strainer board of claim 9 with an upper wall of the outer retainment ring being substantially flush with the main cutting board surface when the basket and aperture are engaged.

11. The strainer board of claim 10 with the outer wall of the outer retainment ring being tapered about five degrees.

12. A strainer board, comprising:
a main cutting surface;
a flexile membrane strainer basket having a perimeter and adapted to be removably inserted into an aperture in the main cutting surface;
the basket including a flexile membrane strainer, a hard plastic outer retainment ring defining the perimeter and a hard plastic inner retainment ring;
the strainer having an outer lip captured by an inner lip of the outer retainment ring and an outer side wall and outer lip of the inner retainment ring, and the outer retainment ring having a plurality of tapered retainers extending inwardly from an inner wall, with the retainers engaged with a lower wall of the outer lip of the inner retainment ring to permanently fix the retainment rings to the membrane strainer;
cooperating structure on the basket perimeter and the cutting surface aperture adapted and arranged to permit positive engagement and disengagement of the basket and aperture under finger pressure and to prevent inadvertent disengagement when the strainer board is in a vertical orientation;
the cooperating structure including a pair of semi-cylindrical engagement ridges disposed at opposite diametrical locations on an outer wall of the outer retainment ring, with the aperture including a pair of engagement lips disposed at opposite diametrical locations, the engagement lips having rounded upper corners and sharp lower corners to engage the engagement ridges, a pair of handles extending from the outer wall of the outer retainment ring above the engagement ridges, a pair of depressions in the aperture above the engagement lips sized to receive the handles, an upper wall of the outer retainment ring being substantially flush with the main strainer board surface when the basket and aperture are engaged, and the outer wall of the outer retainment ring being tapered about five degrees.
